(19) United States
(12) Patent Application Publication
(10) Pub. No.: US 2017/0308858 A1
(43) Pub. Date: Oct. 26, 2017

(54) SYSTEM AND METHOD FOR ASSIGNING LEADS TO SALESPEOPLE

(71) Applicant: Big Wave Systems, LLC, Westlake Village, CA (US)

(72) Inventor: John Edward KURATH, Golden, CO (US)

(21) Appl. No.: 15/137,348

(22) Filed: Apr. 25, 2016

(51) Int. Cl. G06Q 10/10; H04L 29/08; H04L 29/06; H04M 3/493

(52) U.S. Cl. CPC G06Q 10/103; H04M 3/493; G06Q 10/1097; H04L 63/10; H04L 67/12

(57) ABSTRACT

A lead-assigning system for assigning leads to salespeople is provided, including modules for administrator, sales-organization, and salespeople. The administrator module is for setting up a sales-organization account for a sales organization, sales-organization users in the sales-organization account for the sales organization, an email system, and a web-site for the lead-assigning system. The sales-organization module is for managing sales persons, communicating with the email system and logging in the web-site, and managing leads. The salespeople module is for communicating with the sales-organization module and editing lead-contact information in the lead-assigning system. A specific lead contacts the sales-organization through the sales-organization module, and the sales-organization module enters a new lead information to the server or refers the lead to the lead-assigning system, and the sales-organization module sends the lead to an available sales person who is available at the moment, so that the available sales person accepts and manages the lead.

### BACKGROUND OF THE INVENTION

The present invention relates to a system and method for assigning leads to salespeople.

A need for a system and method for assigning leads to salespeople has been present for a long time considering the expansive demands in the everyday life. This invention is directed to solve these problems and satisfy the long-felt need.

### SUMMARY OF THE INVENTION

The present invention contrives to solve the disadvantages of the prior art.

An object of the invention is to provide a system and method for assigning leads to salespeople. . . .

An aspect of the invention provides a lead-assigning system for assigning leads to salespeople.

The lead-assigning system comprises an administrator module, a sales-organization module, and a salespeople module.

The administrator module is provided in a server and configured for setting up a sales-organization account for a sales organization existing separately, a plurality of sales-organization users in the sales-organization account for the sales organization, an email system, and a web-site for the lead-assigning system.

The sales-organization module is provided in the server and configured for managing a plurality of sales persons in the server, communicating with the email system and logging in the web-site, and managing a plurality of leads.

The salespeople module is provided in the server and configured for communicating with the sales-organization module and editing lead-contact information in the lead-assigning system.

A specific lead contacts the sales-organization through the sales-organization module of the lead-assigning system, and the sales-organization module enters a lead information to the server if the lead is new to the lead-assigning system or refers the lead to the lead-assigning system, and the sales-organization module sends the lead to an available sales person who is activated in the salespeople module and available at the moment, so that the available sales person accepts and manages the lead.

The sales-organization module may communicate with one or more sales persons to determine the available sales person.

The lead information may be entered by the lead through the web-site.

The lead information may be entered by an employee of the sales organization or an authorized person through a password-protected website communicating the web-site.

The lead information may be entered one by one or uploaded in a bulk from a data file such as a spreadsheet.

An application programming interface (API) may be provided to the sales organization or one or more strategic partners, so that the lead information is entered through the API by the sales organization or one or more strategic partners.

The sales organization or one or more strategic partners may be configured for capturing the lead information through a way comprising a web page thereof, a proprietary software, a customer relationship management (CRM) system, or interactive voice response (IVR) system.

The salespeople module may be further configured for downloading the API from the sales-organization module to a mobile device.

The salespeople module may be configured for communicating with the sales-organization module and agreeing to company terms and use provided by the sales-organization module.

The salespeople module may be further configured for registering as a user of the lead-assigning system.

The sales-organization module may be further configured for activating or deactivating a specific sales person so as to control which sales persons accept leads from the sales-organization module.

The available sales person may notify the sales-organization module of accepting the lead, updating the lead status in the sales-organization module and the salespeople module.

The available sales person may follow up on and contacts the lead, provides quotes to the lead, and sells a policy to the lead, updating the lead status in the sales-organization module and the salespeople module.

The sales-organization module may provide the available sales person with performance metrics for a given time frame and by sales person.

The salespeople module may provide the available sales person with performance metrics for a given time frame and by sales person.

The lead information may comprise a first name, a last name, a preferred contact method including phone, cellphone, and email, a contact information, and a zip code.

The advantages of the present invention are: (1) the system for assigning leads to salespeople * * *; and (2) the method for assigning leads to salespeople * * *.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a schematic diagram showing business functions performed by a system and method for assigning leads to salespeople according to an embodiment of the invention;

FIG. 2 is another schematic diagram showing functions and roles performed by components of a system for assigning leads to salespeople according to another embodiment of the invention;

FIG. 3 is a block diagram showing a system for assigning leads according to an embodiment of the invention;

FIG. 4 is a block diagram showing a pass-protected website connecting between the website of the system and authorized person or employee of the sales organization; and

FIG. 5 is a flowchart showing a method for assigning leads according to another embodiment of the invention.

### DETAILED DESCRIPTION EMBODIMENTS OF THE INVENTION

Referring to the figures, the embodiments of the invention are described in detail.

The present invention provides a system (referred as “Big Wave System” below) and method for assigning leads to salespeople using an algorithm which ensures leads are assigned to salespeople, and accepted and managed to a “sold” status in the most efficient and productive manner.

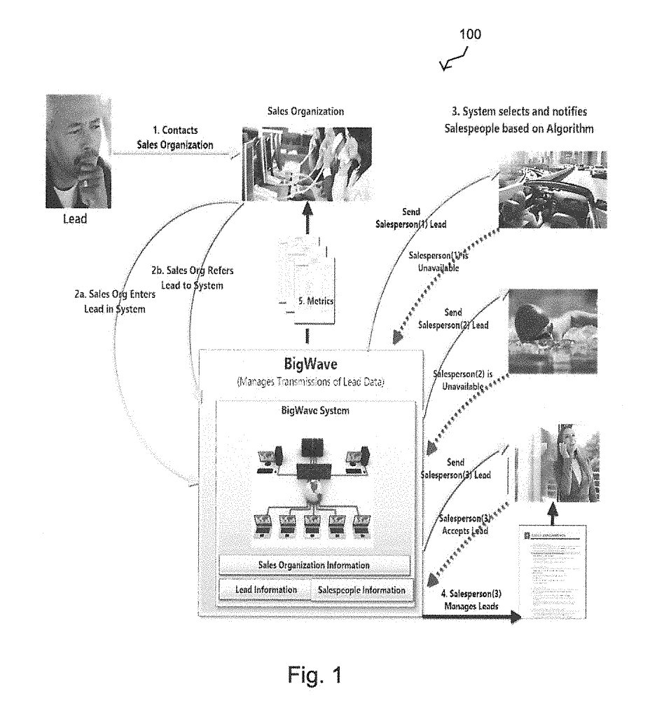

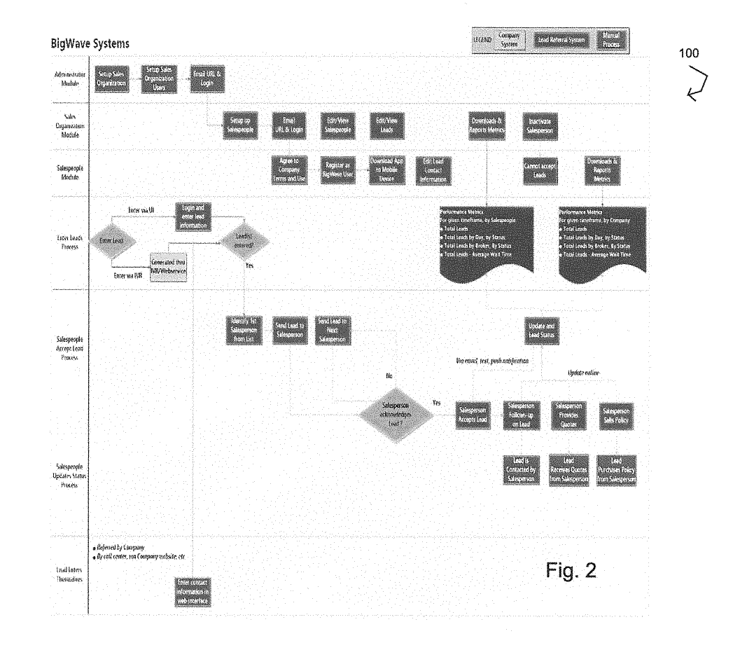

The business functions the system supports include the followings as shown in FIGS. 1 and 2.

The Big Wave System comprises the following steps or unit for executing such steps.

A method for entering and assigning Leads to salespeople based on special customizations for each sales organization includes: Sales Organization branding; Algorithm (based on sales organization defined salesperson and lead custom attributes, calculation for assignment, etc.); Timeliness (salesperson time to accept=X minutes, run algorithm every # minutes, etc.); Sales Organization specific Lead landing page; and Bulk load spreadsheets, etc.

User interface may be designed for screen top or other mobile device.

Basic functional components of Big Wave Systems includes: Add/Edit/Inactivate Administrators; Add/Edit/Inactivate Sales Organization; Add/Edit/View/Inactivate Sales Organization users; Add Salespeople in bulk or individually and Register/Edit/Inactivate, and View current Salesperson information and historical Lead information of Leads assigned; Add Leads individually via user interface, IVRO web service, refer lead to website, and Edit/View current and historical Lead information of Lead status changes; Assign Leads based on the algorithm to Salespeople (open, pending, pending off line, reject, accept); Accept or Reject Leads (accept or reject) via email, text, push notification; Manage Leads to end of life cycle (follow-up, quote, sold, delayed, deferred, not a good prospect); and Metrics reporting of current and historical Lead information (grand totals, by day, by salesperson, average pickup).

Other features of Big Wave Systems includes: Ability to re-invite/resend Salesperson invite to register; Ability to reassign Leads (in open, pending, pending off line, etc.) to a specific Salesperson; Ability to suspend salespeople (have access to system, but cannot accept Leads).

Security features for Big Wave Systems includes: Two factor unique user identification, password encryption, password management, inactivity expiration, etc.; Roles limited in access to other Sales Organizations information, and to information on a need to know basis including Administrator, Sales Organization Users (Power, Enter Leads, Metrics), Salesperson, Lead; and Audit trails on changes to Lead contact and record information.

There are a number of ways a lead can be entered/loaded into the system. The possibilities are unlimited but here are the ways Big Wave currently supports.

Leads can be entered directly into the Big Wave website (or a private labeled version). They can be entered by the lead themselves (e.g. the lead is browsing the Sales Organization's website and clicks on a link to have a Salesperson contact them. The link then takes them to a private labeled version of the Big Wave lead entry page and the lead enters their own information).

Sales Organization employees or other authorized persons will also have access to one or more password protected pages (based on their role type in the system). Once logged in, the system allows them to enter leads one at a time via a web page or bulk upload leads from a spreadsheet or other format.

The Big Wave system exposes its API (Application Programming Interface) to Sales Organizations and other Strategic Partners. The Sales Organization can capture the lead information in many different ways. Some examples would include their own web page, proprietary software, CRM (Customer Relationship Management) system, IVR (Interactive Voice Response) system, etc.

The information gathered for each lead will vary based on the needs and requirements of the Sales Organization. There are basic fields that are captured (listed below). However, in addition to the basic fields, each Sales Organization may request custom fields (e.g. preferred language, product type, preferred contact time, etc.).

In general the basic information captured may include first name, last name, preferred contact method (e.g. phone, cellphone, email, etc.), contact information (depends on preferred contact method, for example phone number or email address), and zip code.

The system described in the above can be realized using information processing devices including computers, smart phones, other personal electronic devices.

The functions and processes among the modules are configured to be performed in one of the above information processing devices or their central processing units, internal memories, or external storing devices.

Each of the functions and processes can be performed by one or more computer programs executed in the information processing devices, changing the electronic physical states thereof.

For example, a module as mentioned in the above and below, can be a customized hardware or a purely software configured to perform its proper operations as described in the above.

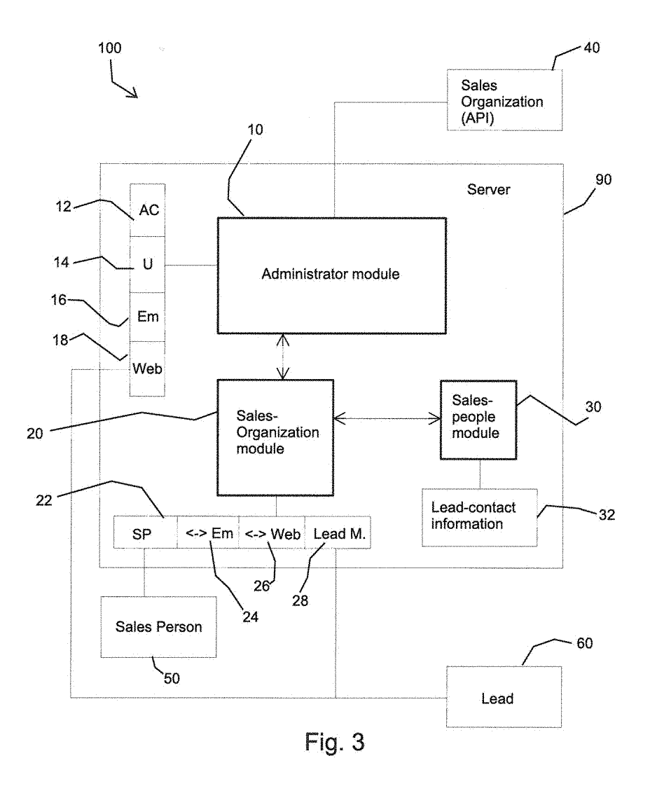

As shown in FIGS. 1-4, an aspect of the invention provides a lead-assigning system 100 for assigning leads to salespeople.

The lead-assigning system 100 comprises an administrator module 10, a sales-organization module 20, and a salespeople module 30.

The administrator module 10 is provided in a server 90 and configured for setting up a sales-organization account 12 for a sales organization 40 existing separately, a plurality of sales-organization users 14 in the sales-organization account 12 for the sales organization 40, an email system 16, and a web-site 18 for the lead-assigning system 100.

The sales-organization module 20 is provided in the server 90 and configured for managing a plurality of sales persons 50 in the server 90, communicating with the email system 16 and logging in the web-site 18, and managing a plurality of leads 60.

As discussed in the above, the sales-organization account 12 can be realized in various forms in the system 100. Any number of sales organizations 40 can be set up with corresponding accounts 12 in the system 100.

The plurality of sales-organization users 14 are users registered in the sales organization 40, including clients and employees of the sales organization 40. They can be set up in the sales-organization module 20, or anywhere in the server 90.

Likewise, the email system 16 and the web-site 18 can be set up in the sales-organization module 20, or anywhere in the server 90, and can be accessed internally by any of the modules or even from outside of the server 90.

Especially, the connections among the components in the server 90 can be very flexible according to the art. Therefore, two components, which are not connected directly in the figures, can be accessed through the other components.

The salespeople module 30 is provided in the server 90 and configured for communicating with the sales-organization module 20 and editing lead-contact information 32 in the lead-assigning system 100.

In certain embodiments of the invention, one or more modules (10, 20, 30) may be disposed in a separate place other than the server 90. If the system 100 can be said to be in a large network, for example, the internet, then the one or more modules (10, 20, 30) may be located anywhere in the internet. Sometimes, the server 90 itself can be omitted altogether, which is definitely not limiting the structure of the system and the environment.

A specific lead 60 contacts the sales-organization 40 through the sales-organization module 20 of the lead-assigning system 100, and the sales-organization module 20 enters a lead information to the server 90 if the lead 60 is new to the lead-assigning system 100 or refers the lead 60 to the lead-assigning system 100, and the sales-organization module 20 sends the lead 60 to an available sales person 50 who is activated in the salespeople module 30 and available at the moment, so that the available sales person 50 accepts and manages the lead 60.

The sales-organization module 20 may communicate with one or more sales persons 50 to determine the available sales person.

The lead information may be entered by the lead 60 through the web-site 18.

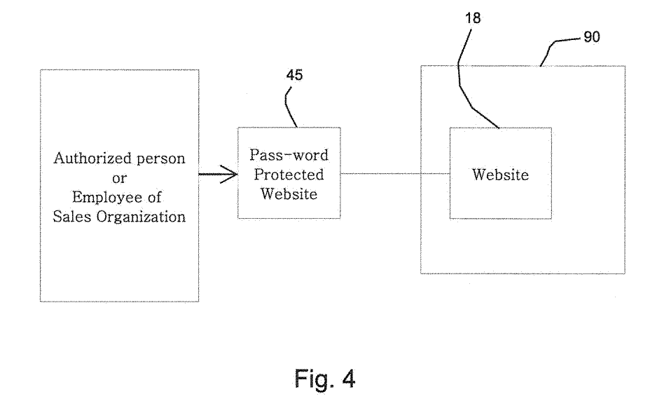

The lead information may be entered by an employee of the sales organization or an authorized person through a password-protected website 45 communicating the web-site 18 as shown in FIG. 4.

The lead information may be entered one by one or uploaded in a bulk from a data file such as a spreadsheet.

An application programming interface (API) may be provided to the sales organization 40 or one or more strategic partners, so that the lead information is entered through the API by the sales organization 40 or one or more strategic partners.

The sales organization 40 or one or more strategic partners may be configured for capturing the lead information through a way comprising a web page thereof, a proprietary software, a customer relationship management (CRM) system, or interactive voice response (IVR) system.

The salespeople module 30 may be further configured for downloading the API from the sales-organization module 20 to a mobile device (not shown) possessed by the sales person 50.

The salespeople module 30 may be configured for communicating with the sales-organization module 20 and agreeing to company terms and use provided by the sales-organization module 20.

The salespeople module 30 may be further configured for registering as a user of the lead-assigning system 100, which includes the sales organizations 40, the sales persons 50, the leads 60, and even the clients or employees of the sales organization 40.

The sales-organization module 20 may be further configured for activating or deactivating a specific sales person 50 so as to control which sales persons 50 accept leads 60 from the sales-organization module 20.

The available sales person 50 may notify the sales-organization module 20 of accepting the lead 60, updating the lead status in the sales-organization module 20 and the salespeople module 30.

The available sales person 50 may follow up on and contacts the lead 60, provides quotes to the lead 60, and sells a policy to the lead 60, updating the lead status in the sales-organization module 20 and the salespeople module 30.

The sales-organization module 20 may provide the available sales person 50 with performance metrics for a given time frame and by sales person 50.

The salespeople module 30 may provide the available sales person 50 with performance metrics for a given time frame and by sales person 50.

The lead information may comprise a first name, a last name, a preferred contact method including phone, cellphone, and email, a contact information, and a zip code.

In

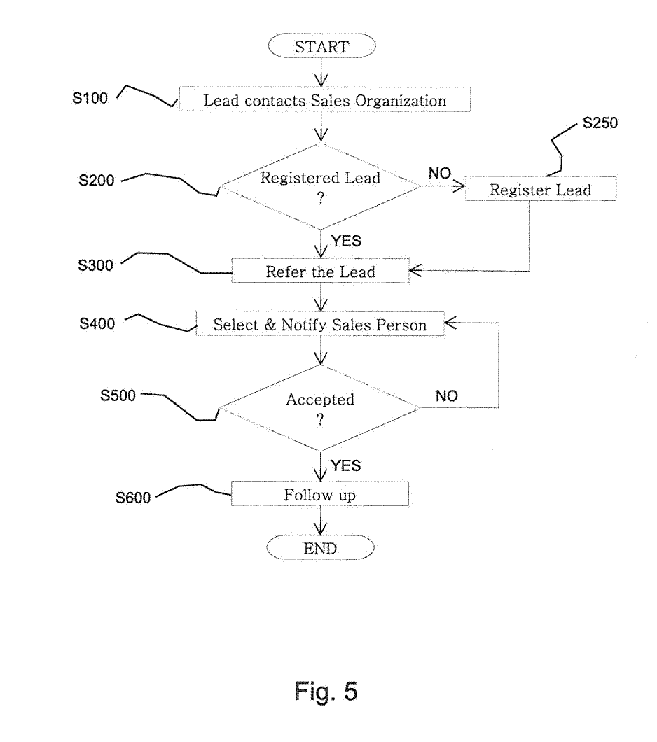

FIG. 5 is a flowchart showing a method for assigning leads according to another embodiment of the invention.

As shown in FIGS. 1, 2, and 5, the lead 60 contact one of the sales organization 40 for a potential need of service or commodity (S100).

If the lead 60 is new to the system (S200, S250), then the sales organization 40 registers the lead 60 as a new lead in the server 90 and refer the lead 60, registered already or newly, to the system 100 (S300).

Then the system 100 selects and notifies the lead 60 to a sales person 50 until accepted and followed up by the sales person 50 (S500, S600).

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A lead-assigning system for assigning leads to salespeople, the lead-assigning system comprising:
an administrator module provided in a server and configured for setting up a sales-organization account for a sales organization existing separately, a plurality of sales-organization users in the sales-organization account for the sales organization, an email system, and a web-site for the lead-assigning system;
a sales-organization module provided in the server and configured for managing a plurality of sales persons in the server, communicating with the email system and logging in the web-site, and managing a plurality of leads; and
a salespeople module provided in the server and configured for communicating with the sales-organization module and editing lead-contact information in the lead-assigning system,
wherein a specific lead contacts the sales-organization through the sales-organization module of the lead-assigning system, and the sales-organization module enters a lead information to the server if the lead is new to the lead-assigning system or refers the lead to the lead-assigning system, and the sales-organization module sends the lead to an available sales person who is activated in the salespeople module and available at the moment, so that the available sales person accepts and manages the lead.

2. The lead-assigning system of claim 1, wherein the sales-organization module communicates with one or more sales persons to determine the available sales person.

3. The lead-assigning system of claim 1, wherein the lead information is entered by the lead through the web-site.

4. The lead-assigning system of claim 1, wherein the lead information is entered by an employee of the sales organization or an authorized person through a password-protected website communicating the web-site.

5. The lead-assigning system of claim 4, wherein the lead information is entered one by one or uploaded in a bulk from a data file such as a spreadsheet.

6. The lead-assigning system of claim 1, wherein an application programming interface (API) is provided to the sales organization or one or more strategic partners, so that the lead information is entered through the API by the sales organization or one or more strategic partners.

7. The lead-assigning system of claim 6, wherein the sales organization or one or more strategic partners are configured for capturing the lead information through a way comprising a web page thereof, a proprietary software, a customer relationship management (CRM) system, or interactive voice response (IVR) system.

8. The lead-assigning system of claim 6, wherein the salespeople module is further configured for downloading the API from the sales-organization module to a mobile device.

9. The lead-assigning system of claim 1, wherein the salespeople module is configured for communicating with the sales-organization module and agreeing to company terms and use provided by the sales-organization module.

10. The lead-assigning system of claim 1, wherein the salespeople module is further configured for registering as a user of the lead-assigning system.

11. The lead-assigning system of claim 1, wherein the sales-organization module is further configured for activating or deactivating a specific sales person so as to control which sales persons accept leads from the sales-organization module.

12. The lead-assigning system of claim 1, wherein the available sales person notifies the sales-organization module of accepting the lead, updating the lead status in the sales-organization module and the salespeople module.

13. The lead-assigning system of claim 12, wherein the available sales person follows up on and contacts the lead, provides quotes to the lead, and sells a policy to the lead, updating the lead status in the sales-organization module and the salespeople module.

14. The lead-assigning system of claim 13, wherein the sales-organization module provides the available sales person with performance metrics for a given time frame and by sales person.

15. The lead-assigning system of claim 13, wherein the salespeople module provides the available sales person with performance metrics for a given time frame and by sales person.

16. The lead-assigning system of claim 1, wherein the lead information comprises a first name, a last name, a preferred contact method including phone, cellphone, and email, a contact information, and a zip code.
